(19) United States
(12) Patent Application Publication
(10) Pub. No.: US 2015/0120131 A1
(43) Pub. Date: Apr. 30, 2015

(54) COMMUNICATION SYSTEM BETWEEN ELECTRIC BIKES AND COMMUNICATION METHOD THEREOF

(71) Applicant: National Chiao Tung University, Hsinchu City (TW)

(72) Inventors: Yi CHANG, Hsinchu City (TW); Wei-Hua CHIENG, Hsinchu City (US); Shyr-Long JENG, Hsinchu County (TW); Stone CHENG, Hsinchu City (TW); Fu-Jen HSU, Taichung City (TW); Bin-Han LUE, Pingzhen City (TW); Chih-Chiang WU, Hsinchu City (TW); Ching-Wei SHIH, Hsinchu City (TW)

(73) Assignee: National Chiao Tung University, Hsinchu City (TW)

(21) Appl. No.: 14/168,160

(22) Filed: Jan. 30, 2014

(30) Foreign Application Priority Data
Oct. 31, 2013 (TW) 102139574

(51) Int. Cl. G07C 5/08; H04W 84/12; H04B 7/26; H04W 84/00

(52) U.S. Cl. CPC G07C 5/0808; H04W 84/005; H04W 84/12; H04B 7/26
USPC 701/29.3

(57) ABSTRACT

The present invention provides a communication system between electric bikes and communication method thereof. The communication system comprises a plurality of electric bikes. Each of the electric bikes comprises a monitor module and a portable electric device, wherein the portable device further comprises a storing unit and a WiFi module. The monitor module is configured to monitor the status of the electric bike to generate a plurality of monitor information. When a temporary network is formed between the electric bikes, the electric bikes transmit the monitor information each other through the temporary network and each of the electric bikes stores the received monitor information.

### BACKGROUND OF THE INVENTION

1. Field of the Invention

The present invention relates to a communication system between electric bikes, more particularly to a communication system between electric bikes and communication method thereof.

2. Description of the Prior Art

The electric bike has already been widely used in the whole world. A lot of bike fans will form the bike team to go out in a group. When the bike team goes out, the most important thing is the safety of all team members. Thus, for the bike team leader, it is necessary to grasp the status of all team members upon riding, so that it will be able to provide suitable support when team members meet the accidental status suddenly. At present, a lot of apparatuses can be used to the electric bike team leader to grasp the member's status at any time, such as the global positioning system (GPS) can be used to know current position of team member, and the radio can be used to communicate with team members at any time.

Because the electric bike users increase day by day, the electric bike team has increased to the demand for the auxiliary equipment gradually, such as the safety assistance system etc. However, the study on this part is scarce by every large manufacturer. This will bring considerable resistance for popularizing the product.

In addition, upon considering environment and human interference, and complexity and quantity of the signal line, general bike auxiliary equipment manufacturers will use wireless communication equipment usually, but the cost of wireless communication equipment is quite high, and the signal is apt to be covered, interfered by various obstacle sources in the city, which will cause low efficiency. On the other hand, because the electricity is required for the abovementioned equipment, in order to reduce the electricity consumption, the manufacturer usually adopts the wireless communication chip that consumes low energy, and this will limit the transmission distance greatly.

### SUMMARY OF THE INVENTION

Inasmuch as this aspect, the present invention provides a communication system between electric bikes and the communication method thereof, in order to solve the problem of the above mentioned prior art.

The present invention provides a communication system between electric bikes. The communication system includes a plurality of electric bikes. Each of the electric bikes includes a monitor module and a portable electric device, wherein the portable device further includes a storing unit and a WiFi module. The monitor module is configured to monitor the status of the electric bike to generate a plurality of monitor information. When the portable electric device is disposed on the electric bike, the storing unit stores the monitor information from the monitor module. The WiFi module is connected to the storing unit electrically. When a temporary network is formed between the electric bikes, the electric bikes transmit the monitor information each other through the temporary network and each of the electric bikes stores the received monitor information.

In a demonstrative embodiment of the present invention, each of the electric bikes further comprises a battery, when the portable electric device is disposed on the electric bike, the operation power of the portable electric device is provided by the battery of the electric bike.

In a demonstrative embodiment of the present invention, the portable electric device provides a user interface, wherein the user interface at least displays one of speed, battery capacity and controller temperature of the electric bike via those monitor information.

In a demonstrative embodiment of the present invention, the portable electric device provides a user interface, wherein the user interface at least displays one of speed, battery capacity and controller temperature of other electric bike via the monitor information of other electric bike received by the WiFi module.

In a demonstrative embodiment of the present invention, the portable electric device provides a user interface, wherein the user interface comprises a real-time voice communication function, and the electric bike can transmits the real-time voice via the temporary network.

In a demonstrative embodiment of the present invention, the temporary network can be finished by the following steps: (a) Using the WiFi module of each portable electric device to create a network protocol; and (b) Searching other moving main unit to connect and create the temporary network.

In a demonstrative embodiment of the present invention, after the temporary network is created, if the WiFi module of the electric bike detects one of moving main units is logged out, the WiFi module of the electric bike will delete the member of that moving main unit from the temporary network.

The present invention also provides a communication method between electric bikes, comprising: (a) disposing the portable electric device on a plurality of electric bikes; (b) using the WiFi module of portable electric device to form the temporary network; and (c) using the temporary network to transmit to transmit the monitor information each other in the electric bikes.

In a demonstrative embodiment of the present invention, the communication method further comprising: (d) using a user interface to show the monitor information of electric bikes at local end.

In a demonstrative embodiment of the present invention, the communication method further comprising: (e) using a user interface to show the monitor information of electric bikes at remote end.

In a demonstrative embodiment of the present invention, the communication method further comprising: (f) using a user interface to provide a real-time voice communication function, wherein the electric bikes transmit the real-time voice through the temporary network.

In a demonstrative embodiment of the present invention, the Step (b) further comprising: (b1) using the WiFi module of each portable electric device to create a network protocol; and (b2) searching other moving main unit to connect and create the temporary network.

In a demonstrative embodiment of the present invention, the communication method further comprising: (g) using the WiFi module of electric bike to detect if there is any moving main units be logged out, if yes, the WiFi module of the electric bike will delete the member of that moving main unit from the temporary network.

Based on the abovementioned description, according to the present invention, the communication system and communication method between electric bikes utilizes common portable electric device (such as intellectual cell phone) of people to simplify the complexity of telecommunication equipment, which not only can reduce the cost of bike team but also can facilitate the organizational activities. In addition, the communication system and communication method between electric bikes can be used in different operation system platform easily and quickly, in order to achieve efficient communication between electric bikes.

It has to understand that the abovementioned general description and the following embodiments are only illustrative and explanative, which cannot limit the range of claim advocated by the present invention.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows the illustration for the communication system between the electric bikes of the present invention.

FIG. 2 shows the illustration for the user interface of the present invention.

FIG. 3 shows the illustration for the communication method between the electric bikes of the present invention.

### DESCRIPTION OF THE PREFERRED EMBODIMENT

It is going to consult the demonstrative embodiment of the present invention in detail now, and explain the embodiment in figures. In addition, the same device/component is used in the figures for representing the same or similar part.

In the following embodiments, when the device is regarded as “connect” or “couple” to another device, it can be considered as connect or couple to another device directly, or the device between them. In addition, the sequence of method can be varied.

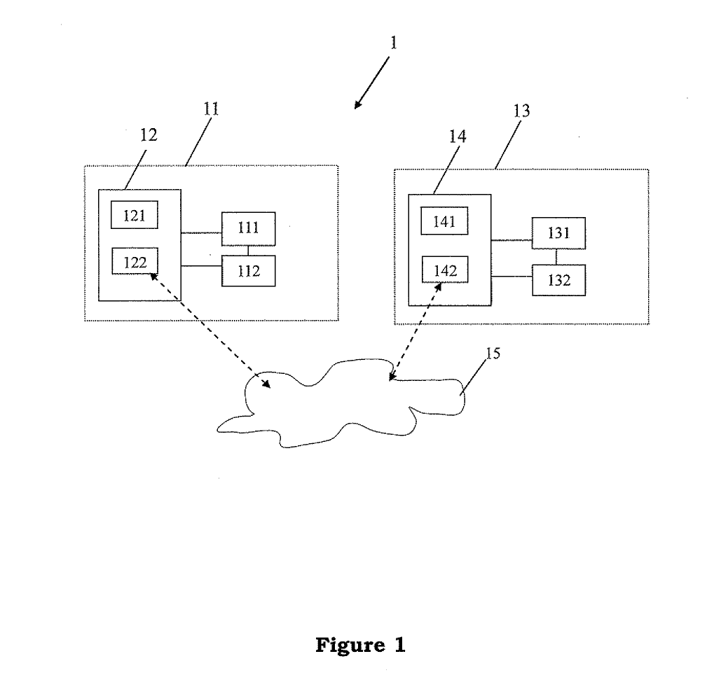

FIG. 1 displays the illustration for the communication system between the electric bikes of the present invention. In FIG. 1, the communication system 1 comprises: the electric bikes 11, 13, in which the electric bikes 11, 13 include the portable electric device 12, 14, the monitor module 112, 132 and the battery 111, 131. The portable electric device 12, 14 further include the storing unit 121, 141 and WiFi module 122, 142. The WiFi module 122, 142 can create a temporary network 15 through the Ad-hoc. In this embodiment, the peer-to-peer (equivalent network) technique is used to create the connection of Ad-hoc.

In an embodiment of the present invention, the electric bikes 11, 13 may be the electric bicycles or the electric motorcycles with rated power lower than 400 W. But it will not be limited in other embodiment. In addition, the structure of abovementioned electric bikes 11, 13 may comprises: common bicycle device, battery, control system, generator, and below 40 kg for bicycle including battery, below 48V for rated voltage of battery, and power off within 3 seconds for speed above 30 km/h, and the port connecting the battery to the portable electric device 12, 14.

The abovementioned monitor module 112, 132 electrically connects the battery 111, 131 to get power from the battery 111, 131, and the monitor module 112, 132 can get the monitor information of battery capacity from the transmission interface of battery 111. In an embodiment of the present invention, the monitor module 112, 132 monitor the state of electric bikes 11, 13, in order to generate a plurality of monitor information, For example: the monitor module 112 monitors the electric bike 11, in order to generate a plurality of monitor information, including the speed, battery capacity, and controller temperature of the electric bike 11.

In an embodiment of the present invention, the electric bikes 11, 13 can further include a connector receptacle (not shown in Figure). This connector receptacle can electrically connect the battery 111, 131 and the monitor module 112, 132 of the electric bikes 11, 13. The portable electric device 12, 14 can connects the electric bikes 11, 13 through the connector receptacle. The portable electric device 12, 14 can electrically connect the battery 111, 131 and the monitor module 112, 132 through the connector receptacle. In an embodiment of the present invention, the portable electric device 12, 14 is a flat panel device. In other embodiment, the portable electric device 12, 14 may be the intellectual cell phone, intellectual watch, intellectual glasses or super thin notebook PC, which is not limited in the present invention. When the portable electric device 12 is disposed on the electric bike 11, the operation power of the portable electric device 12 is provided by the battery 11 of the electric bike 11. In addition, the portable electric device 12 can electrically connect the monitor module 112 through the connector receptacle, and receive a plurality of monitor information from the monitor module 112 through the transmission bus, and store them in the storing unit 121.

In addition, when the portable electric device 12 is disposed on the electric bike 11, and when the portable electric device 14 is disposed on the electric bike 13, the WiFi module 122, 142 can create a temporary network 15 through the Ad-hoc, so that the electric bikes 11, 13 can transmit and store these monitor information through the WiFi module 122, 142. It means that the electric bike 11 can transmit a plurality of monitor information from the monitor module 112 to the electric bike 13 through the WiFi module 122 and the temporary network 15, so that the storing unit 141 of the portable electric device 14 of the electric bike 13 can store a plurality of monitor information of the electric bike 13 and a plurality of monitor information of the electric bike 11. Similarly, the storing unit 121 of the portable electric device 12 of the electric bikes 12 can store a plurality of monitor information of the electric bikes 12 and a plurality of monitor information of the electric bike 13.

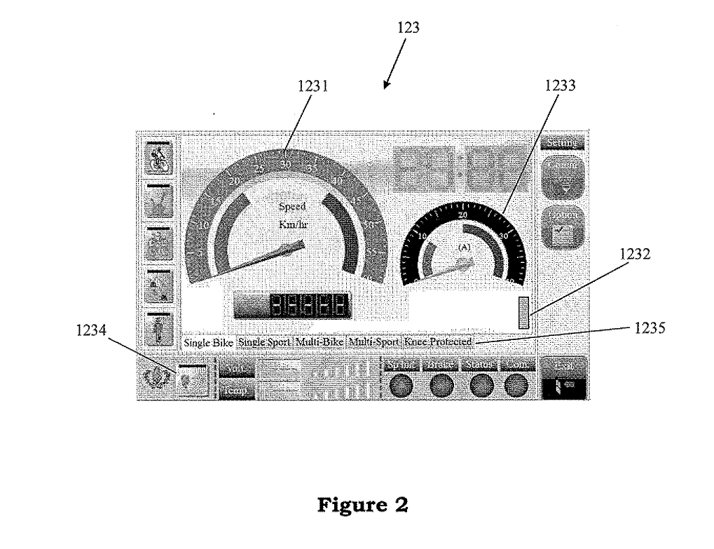

FIG. 2 displays the illustration for the user interface of the present invention. Please refer to FIG. 1 for the description of FIG. 2. The abovementioned storing unit 121 of the portable electric device 12 stores an application program (APP). When the portable electric device 12 and the electric bike 11 are connected electrically, the abovementioned APP can be executed automatically. In other embodiment, when the portable electric device 12 and the electric bike 11 are connected electrically, the abovementioned APP can also be operated by the user for the execution.

When the abovementioned APP is executed, the APP can control the portable electric device 12 to obtain a plurality of monitor information of the electric bike 11 from the monitor module 112, and store them in the storing unit 121. In addition, the APP can further control the WiFi module 122 to search other moving main unit to create the temporary network 15. After the temporary network 15 is created, the APP can control the portable electric device 12 to obtain a plurality of monitor information from the electric bikes 12. The abovementioned APP can let a display unit (not shown in Figure) of the portable electric device 12 to provide a user interface 123.

The abovementioned user interface 123 can disclose the monitor information of the electric bike 11 at local end, such as the speed 1231, the battery capacity 1232 and the controller temperature 1233 of the electric bike 11. Of course, the user can also use the touch way to select other operation label 1235 of user interface 123, in order to switch to multiple bicycle modes, so that the user interface 123 of portable electric device 12 can display a plurality of monitor information the electric bike 13 (remote bicycle).

In addition, in an embodiment of the present invention, the user interface 123 can also provide a real-time voice communication function 1234. The user can transmit the real-time voice to the portable electric device 14 of other bicycle through the real-time voice communication function 1234, the loudspeaker and microphone of portable electric device 12, and the temporary network 15, so that the user can carry on the conversation among a group of bicycles through the temporary network 15.

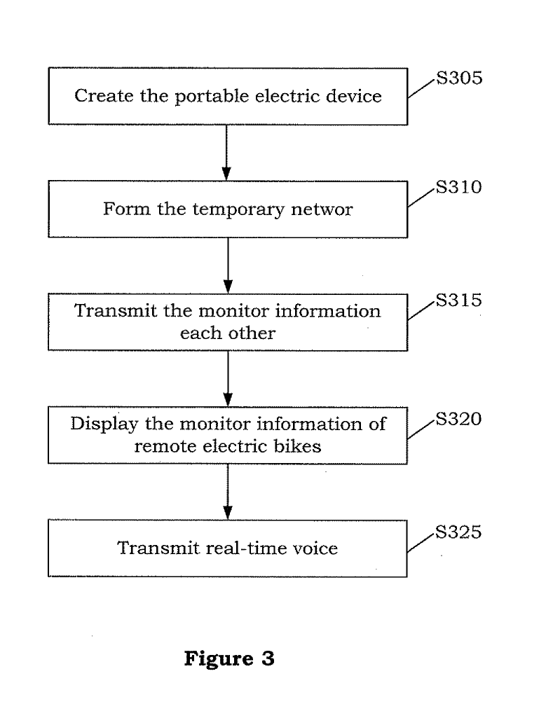

FIG. 3 displays the illustration for the communication method between the electric bikes of the present invention. Please also refer to FIG. 1 and FIG. 2 for the description of FIG. 3. In Step S305, the portable electric device 12, 14 is disposed on the electric bikes 11, 13. As the abovementioned description, the portable electric device 12, 14 can electrically connects the battery 111, 131 and the monitor module 112, 132 through the connector receptacle of the electric bikes 11, 13. In addition, the APP of portable electric device 12, 14 can start to execute.

In Step S310 of FIG. 3, the APP controls the WiFi module 122, 142 to create the temporary network 15. The APP can create a network protocol through the WiFi module 122, 142, for example: log in the local network server of People Near Me server (PNMs) first to search other adjacent moving main units, in order to connect and create the temporary network 15. In addition, the APP registers its identifiable ID through the WiFi module 122, 142. After logging in, the system will search the moving main unit at the near end. If it is found, the system will start to connect the on-line user and plan to transmit and receive information.

In Step S315 of FIG. 3, the portable electric device 12, 14 can transmit each of monitor information of the electric bikes 11, 13 through its WiFi module 122, 142.

In Step S320 of FIG. 3, the user interface 123 can be controlled to display the monitor information of electric bike 11 at local end or display the monitor information of electric bike 13 at remote end.

In Step S325 of FIG. 3, the user interface 123 can be controlled to execute the real-time voice communication function 1234. After the conversation function of the real-time voice communication function 1234 is selected, it will be able to converse with the teammate opening the conversation function too. After the conversation function is opened, the system will initialize the required parameter of information transmission and receive the voice from the designated address.

After the abovementioned real-time voice communication function 1234 is activated, and the volume is set up and the transmission range of voice initialization attribute is confirmed, the voice transmission device (205) is initialized. The broadcasting voice points per second are set as 11025 for 11 KHz, 22050 for 22 KHz, and 44100 for 44 KHz. After it is finished, the Wave voice transmission mode is set and opened. When the user press the conversation function key to converse, and the system will initialize the microphone parameter and open the microphone to receive the voice, and store the voice in the storing unit 121, 141. Then the device for transmitting the voice is created, the format is the same as WaveOut device, the difference is that the receiving microphone device has the buffer area. After it is finished, the voice is compressed and transmitted to another electric bike 13. When the electric bike 13 is broadcasting the voice, the system will receive the voice file of adjacent bicycle and decompress it first, and then decode it in accordance with the voice coding way selected by the user. After it is decoded, the voice broadcasting device will be activated to broadcast the voice. After the conversation function is activated, the user interface 123 will reveal the icon for conversation at this moment. If the conversation mode is going to be closed, press the conversation function key again.

In addition, in an embodiment of the present invention, after the temporary network 15 is created, if the WiFi module 122, 142 of the electric bikes 11,13 detect one of moving main units belonged to the electric bike 13 is logged out, the APP of portable electric device 12 will delete the member of that moving main unit belonged to the electric bike 13 from the temporary network 15, in order to terminate the connection.

In summary, the communication system and communication method between electric bikes provided by the present invention utilizes the portable electric device of electric bikes and the abovementioned monitor information of temporary network created by the WiFi module to simplify the complexity of telecommunication equipment, which not only can reduce the cost of bike team but also can facilitate the organizational activities.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A communication system between electric bikes, comprising:
a plurality of electric bikes, wherein each of the electric bikes comprises:
a monitor module, the monitor module for monitoring each of the plurality of electric bikes to generate a plurality of monitor information; and
a portable electric device, comprising:
a storing unit, when the portable electric device being disposed on the plurality of electric bikes, the storing unit stores the plurality of monitor information; and
a WiFi module, the WiFi module is connected to the storing unit electrically,
wherein the WiFi module of the plurality of electric bikes forms a temporary network, the plurality of electric bikes transmit the plurality of monitor information each other through the temporary network and each of the plurality of electric bikes stores the received monitor information.

2. The system according to claim 1, wherein each of the plurality of electric bikes further comprises a battery, when the portable electric device is disposed on the each electric bike, the operation power of the portable electric device is provided by the battery of each of the plurality of electric bike.

3. The system according to claim 1, wherein the portable electric device provides a user interface, the user interface at least displays one of speed, battery capacity and controller temperature of the each of the plurality of electric bike via the plurality of monitor information.

4. The system according to claim 1, wherein the portable electric device at least displays one of speed, battery capacity and controller temperature of other plurality of electric bikes via the plurality of monitor information of other plurality of electric bikes received by the WiFi module.

5. The system according to claim 1, wherein the portable electric device comprises a real-time voice communication function, and the plurality of electric bikes transmit a real-time voice via the temporary network.

6. The system according to claim 1, wherein the temporary network is achieved by the following steps:
using the WiFi module of each portable electric device to create a network protocol; and
searching other moving main units to connect and create the temporary network.

7. The system according to claim 6, wherein after the temporary network is created, if the WiFi module of the plurality of electric bike detects one of the moving main units is logged out, the WiFi module of plurality of the electric bikes delete a member of the moving main units from the temporary network.

8. A communication method between electric bikes, comprising:
disposing a portable electric device on a plurality of electric bikes;
using a WiFi module of the plurality of portable electric devices to form the temporary network; and
using the temporary network to transmit the plurality of monitor information each other in the plurality of electric bikes.

9. The method according to claim 8, further comprising:
using a user interface to show the plurality of monitor information of the plurality of electric bikes at local end.

10. The method according to claim 8, further comprising:
using a user interface to show the plurality of monitor information of the plurality of electric bikes at remote end.

11. The method according to claim 8, further comprising:
using a user interface to provide a real-time voice communication function, wherein the plurality of electric bikes transmit a real-time voice through the temporary network.

12. The method according to claim 8, wherein the Steps for forming a temporary network by the WiFi module of the plurality of portable electric device further comprising:
using the WiFi module of each of the plurality of portable electric device to create a network protocol; and
searching other moving main units to connect and create the temporary network.

13. The method according to claim 8, further comprising:
using a WiFi module of the plurality of electric bike to detect if whether any moving main units is logged out, if yes, the WiFi module of the plurality of electric bikes deletes a member of the moving main units from the temporary network.
